(19) United States
(12) Patent Application Publication
(10) Pub. No.: US 2008/0195486 A1
(43) Pub. Date: Aug. 14, 2008

(54) Prepaid gasoline transaction platform

(75) Inventors: Brian Israel Sopinsky, Lafayette Hill, PA (US); Thomas John Kennedy, Broomall, PA (US)

Correspondence Address: DRINKER BIDDLE & REATH;ATTN: INTELLECTUAL PROPERTY GROUP, ONE LOGAN SQUARE, 18TH AND CHERRY STREETS, PHILADELPHIA, PA, 19103-6996, US

(73) Assignee: Waves Licensing, LLC

(21) Appl. No.: 12/008,047

(22) Filed: Jan. 8, 2008

Related U.S. Application Data
(60) Provisional application No. 60/900,620, filed on Feb. 9, 2007.

(51) Int. Cl. G06Q 30/00; G06F 17/00

(52) U.S. Cl. 705/14; 705/1

(57) ABSTRACT

Computer-implemented systems and methods for a consumer to buy gasoline at a predetermined price, comprising enabling a consumer to prepay an operator for a selected quantity of gasoline at a prepaid gasoline price determined by an issuer; issuing to the consumer a gasoline debit card for identifying the consumer in connection with gasoline purchases made using the gasoline debit card; enabling the consumer to purchase a quantity of gasoline not to exceed the selected quantity from the operator using the gasoline debit card; and reducing the prepaid quantity of gasoline indicated owed to the consumer by the purchased quantity of gasoline received by the consumer.

### CROSS REFERENCE TO RELATED APPLICATIONS

Reference is made to and priority claimed from U.S. Provisional Application No. 60/900,620, filed Feb. 9, 2007, which is incorporated herein by reference.

### BACKGROUND

The marketplace for fuel (e.g., gasoline) comprises at least three generic types of participants: wholesale suppliers, who supply gasoline to retail outlets; operators of the retail outlets, who provide the gasoline to consumers at the gas pump; and consumers, who purchase the gasoline at the pump.

Recent sudden increases in the wholesale and retail prices of gasoline have highlighted the existence of risks associated with those prices, particularly with regard to the consumer. As costs of production change or speculation drives up the price of gasoline to suppliers, the suppliers pass the increased costs on to their customers, the operators. Similarly, as the costs to operators increase, the operators pass the increased costs on to their customers, the consumers. The consumer, of course, cannot pass his increased costs on to another, and typically must alone bear the increased costs that have been passed on to him. Thus, the market participant who actually bears the risk of increasing gasoline costs is the consumer.

With current practices, retail consumers are not afforded any alternatives to paying at the retail pump the current retail market price of gasoline, regardless of that price. As the price of gasoline increases, essentially the entire burden of paying the increased price falls on the retail consumer at the time he purchases gasoline at the pump.

There exists a need for a new platform that ameliorates the shortcomings of existing practices.

### SUMMARY

The herein described methods and systems provide a computer-implemented prepaid gasoline transaction platform that allows gasoline market participants to reallocate some of the price risks associated with gasoline price fluctuations while allowing consumers to participate in a rewards program associated with the gasoline outlet. In an illustrative implementation, a retail operator can sell gasoline at a predetermined price to a consumer. A consumer price at which the consumer can pre-pay the operator for a predetermined quantity of gasoline is determined. Payment for the predetermined quantity of gasoline is received from the consumer by the operator. A gasoline debit card is issued to the consumer for identifying the consumer and indicating the quantity of gasoline owed to the consumer by the operator (or by an issuer). At least a portion of the gasoline prepaid for is provided to the consumer, such as by a pump at a gas station. The quantity of gasoline indicated owed to the consumer is reduced by the quantity of gasoline provided. In addition, information can be provided or generated based on prepaid gasoline transactions, such as for use in customer programs such as marketing programs directed at the consumer, in response to receiving payment for the gasoline and/or providing the prepaid gasoline to the consumer.

In an exemplary implementation, an issuer can agree with an operator to pay to the operator a price for gasoline based on the market price for gasoline (this price can be based on the current market price for gasoline at the time the issuer and operator enter into an agreement or based on the market price for gasoline when the gasoline is actually redeemed by a consumer). The issuer also agrees with the consumer to guarantee a fixed retail price (e.g., the fixed retail price generally will exceed the market price for gasoline at that time) to the consumer for gasoline to be purchased from the operator. Optionally, the agreements can be effective for a fixed period of time, such as for a period of months. The issuer provides a prepaid gasoline debit account for the consumer, representative of a quantity of gasoline prepaid by the consumer to the issuer at the fixed retail price. The debit account can be provided for the consumer in conjunction with a prepaid gasoline debit card, for indicating the quantity of gasoline prepaid for by the consumer at the fixed retail price. A benefit can be provided to the consumer in accordance with a customer program, such as a marketing program, responsive to receiving pre-payment for the gasoline, and/or providing the paid-for gasoline to the consumer. The difference between the issuer purchase price and the retail market price for gasoline purchased by the consumer can be calculated.

In an exemplary operation, the consumer receives gasoline from the operator, and the consumer's debit account is debited for the quantity of gasoline received. If the retail market price at the time the consumer receives the gasoline is less than the fixed retail price at which the consumer prepaid for the gas, the issuer realizes a gain (and optionally the operator may realize a gain if the operator opted to be paid at the time the gasoline is redeemed by the consumer and not at the time of the issuer/operator agreement). In the exemplary operation, if the retail market price at the time the consumer receives the gasoline rises above the fixed retail price at which the consumer prepaid for the gas, the issuer realizes a loss (and optionally the operator may realize a loss if the operator opted to be paid at the time the gasoline is redeemed by the consumer and not at the time of the issuer/operator agreement). Alternatively, the issuer or the operator can hedge its risk and seek to prevent or reduce its loss.

In the exemplary operation, if the operator opted to be paid at the time of the operator/issuer agreement by the issuer, the operator would have eliminated its loss exposure when the market price of gasoline falls below that price. In this context, the operator would have been paid a price based on the market price at the time of the agreement (and not at the time the gasoline is redeemed by the consumer), which price is higher than the falling market price. As such, unless the issuer successfully hedges its risk, the issuer realizes the brunt of the loss.

In an exemplary implementation, a system for providing prepaid gasoline to a consumer can comprise a gasoline debit card for storing consumer information, a card reader for reading the consumer information, a meter on a gas pump for measuring a pumped quantity of gasoline received by the consumer, a transmitter operatively associated with the card reader and the meter for sending the consumer information and measurement of pumped gasoline to a server. The server has a receiver, and is arranged or configured for receiving the consumer information and measurement of pumped gas, keeping an accounting of the gasoline received by the consumer, and processing the consumer and gasoline received information in accordance with at least one customer program, such as a marketing program directed to the consumer.

Other features of the herein described systems and methods are further described below.

### BRIEF DESCRIPTION OF THE DRAWINGS

The methods and system for a prepaid gasoline transaction platform are further described with reference to the accompanying drawings in which:

FIG. 1 is a block diagram of an exemplary computing environment in accordance with an implementation of the herein described systems and methods;

FIG. 2 is a block diagram showing the cooperation of exemplary components of an illustrative implementation in accordance with the herein described systems and methods;

FIG. 3 is a flow diagram showing the cooperation of exemplary market participants of an illustrative implementation of a prepaid gasoline transaction platform for retail transactions in accordance with the herein described systems and methods;

FIG. 4 is a block diagram showing the cooperation of exemplary components of an illustrative implementation of a prepaid gasoline transaction platform for retail transactions in accordance with the herein described systems and methods;

FIG. 5 is a block diagram showing the cooperation of exemplary components of an illustrative implementation of a prepaid gasoline transaction platform for wholesale transactions in accordance with the herein described systems and methods;

FIG. 6 is a flow diagram showing exemplary processing performed to allow for retail prepaid gasoline transactions in accordance with the herein described systems and methods; and

FIG. 7 is a flow diagram showing exemplary processing performed to allow for illustrative prepaid gasoline transactions in accordance with the herein described systems and methods; and

### DETAILED DESCRIPTION

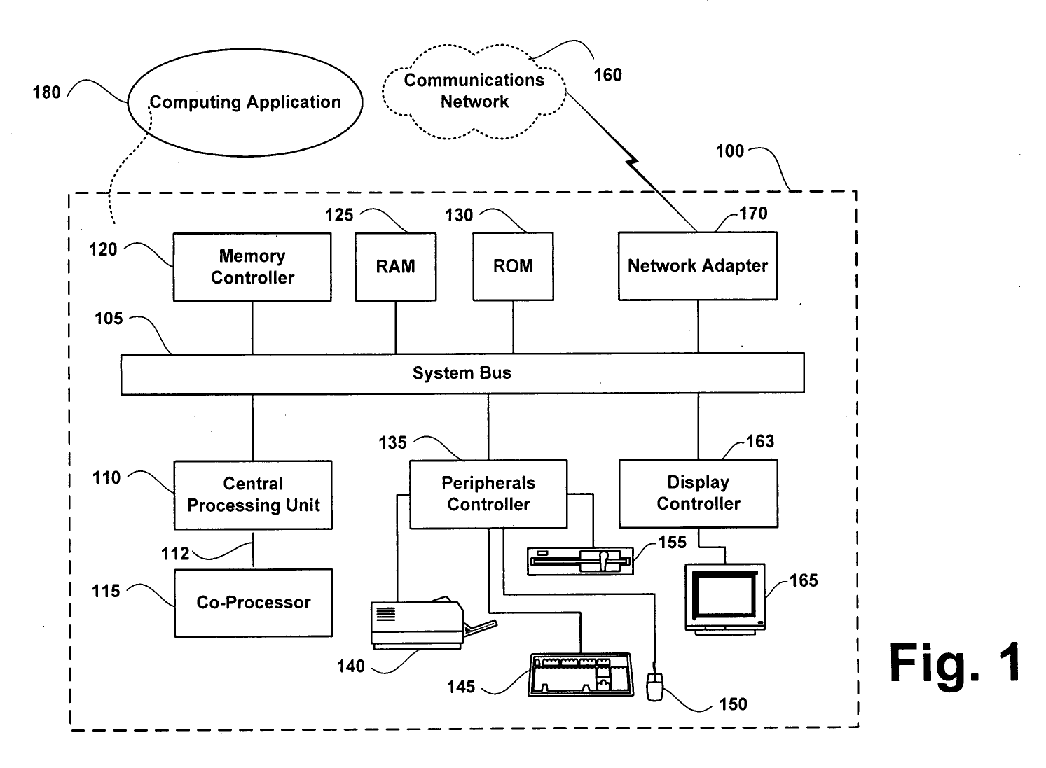

FIG. 1 depicts an exemplary computing system 100 in accordance with herein described system and methods. The computing system 100 is capable of executing a variety of computing applications 180. Computing application 180 can comprise a computing application, a computing applet, a computing program, or other instruction set operative on computing system 100 to perform at least one function, operation, and/or procedure. Exemplary computing system 100 is controlled primarily by computer readable instructions, which may be in the form of software. The computer readable instructions can contain instructions for computing system 100 for storing and accessing the computer readable instructions themselves. Such software may be executed within central processing unit (CPU) 110 to cause the computing system 100 to perform desired functions. In many known computer servers, workstations, and personal computers, CPU 110 is implemented by micro-electronic chips CPUs called microprocessors. A co-processor 115 is an optional processor, distinct from the main CPU 110 that performs additional functions or assists the CPU 110. The CPU 110 may be connected to co-processor 115 through interconnect 112. One common type of coprocessor is the floating-point coprocessor, also called a numeric or math coprocessor, which is designed to perform numeric calculations faster and better than the general-purpose CPU 110.

In operation, the CPU 110 fetches, decodes, and executes instructions, and transfers information to and from other resources via the computer's main data-transfer path, system bus 105. Such a system bus connects the components in the computing system 100 and defines the medium for data exchange. Memory devices coupled to the system bus 105 include random access memory (RAM) 125 and read only memory (ROM) 130. Such memories include circuitry that allows information to be stored and retrieved. The ROMs 130 generally contain stored data that cannot be modified. Data stored in the RAM 125 can be read or changed by CPU 110 or other hardware devices. Access to the RAM 125 and/or ROM 130 may be controlled by memory controller 120. The memory controller 120 may provide an address translation function that translates virtual addresses into physical addresses as instructions are executed.

In addition, the computing system 100 can contain peripherals controller 135 responsible for communicating instructions from the CPU 110 to peripherals, such as, printer 140, keyboard 145, mouse 150, and data storage drive 155. Display 165, which is controlled by a display controller 163, is used to display visual output generated by the computing system 100. Such visual output may include text, graphics, animated graphics, and video. The display controller 163 includes electronic components required to generate a video signal that is sent to display 165. Further, the computing system 100 can contain network adaptor 170 which may be used to connect the computing system 100 to an external communications network 160.

### Illustrative Computer Network Environment:

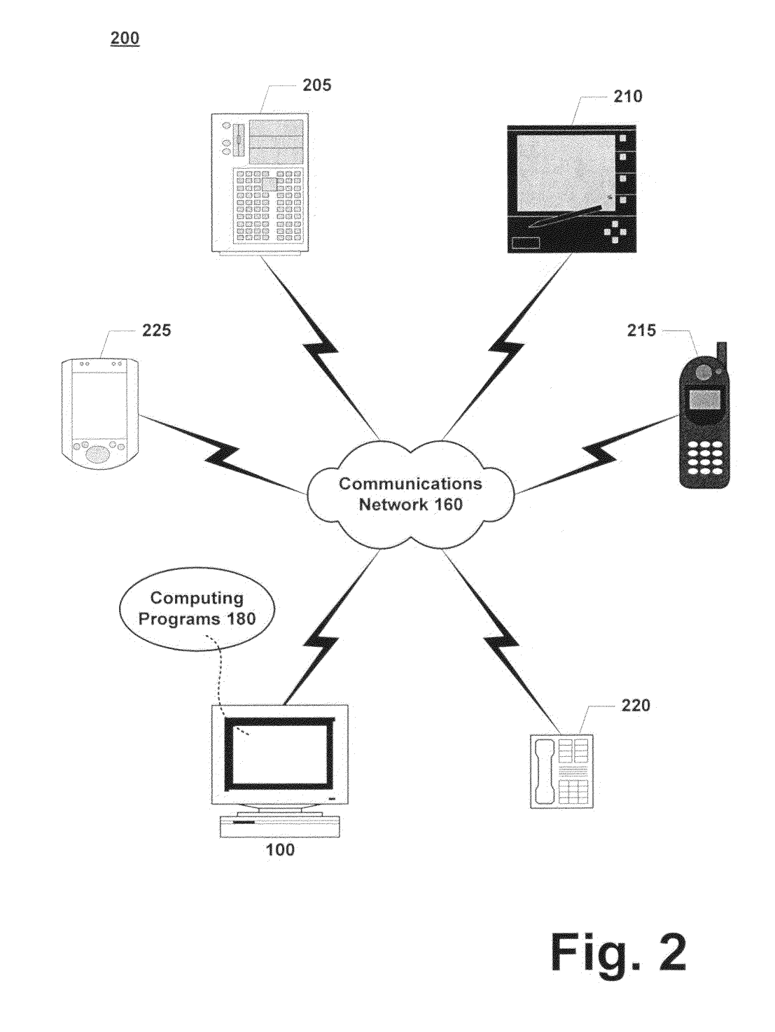

Computing system 100, described above, can be deployed as part of a computer network. In general, the above description for computing environments applies to both server computers and client computers deployed in a network environment. FIG. 2 illustrates an exemplary illustrative networked computing environment 200, with a server in communication with client computers via a communications network, in which the herein described apparatus and methods may be employed. As shown in FIG. 2, server 205 may be interconnected via a communications network 160 (which may be either of, or a combination of, a fixed-wire or wireless LAN, WAN, intranet, extranet, peer-to-peer network, virtual private network, the Internet, or other communications network) with a number of client computing environments such as tablet personal computer 210, mobile telephone 215, telephone 220, personal computer 100, and personal digital assistant 225. In a network environment in which the communications network 160 is the Internet, for example, server 205 can be dedicated computing environment servers operable to process and communicate data to and from client computing environments 100, 210, 215, 220, and 225 via any of a number of known protocols, such as hypertext transfer protocol (HTTP), file transfer protocol (FTP), simple object access protocol (SOAP), or wireless application protocol (WAP). Additionally, networked computing environment 200 can utilize various data security protocols such as secured socket layer (SSL) or pretty good privacy (PGP). Each client computing environment 100, 210, 215, 220, and 225 can be equipped with operating system 180 operable to support one or more computing applications, such as a web browser (not shown), or other graphical user interface (not shown), or a mobile desktop environment (not shown) to gain access to server computing environment 205.

In operation, a user (not shown) may interact with a computing application running on a client computing environment to obtain desired data and/or computing applications. The data and/or computing applications may be stored on server computing environment 205 and communicated to cooperating users through client computing environments 100, 210, 215, 220, and 225, over exemplary communications network 160. A participating user may request access to specific data and applications housed in whole or in part on server computing environment 205. These data may be communicated between client computing environments 100, 210, 215, 220, and 220 and server computing environments for processing and storage. Server computing environment 205 may host computing applications, processes and applets for the generation, authentication, encryption, and communication data and applications and may cooperate with other server computing environments (not shown), third party service providers (not shown), network attached storage (NAS), and storage area networks (SAN) to realize application/data transactions.

### Prepaid Gasoline Transactions:

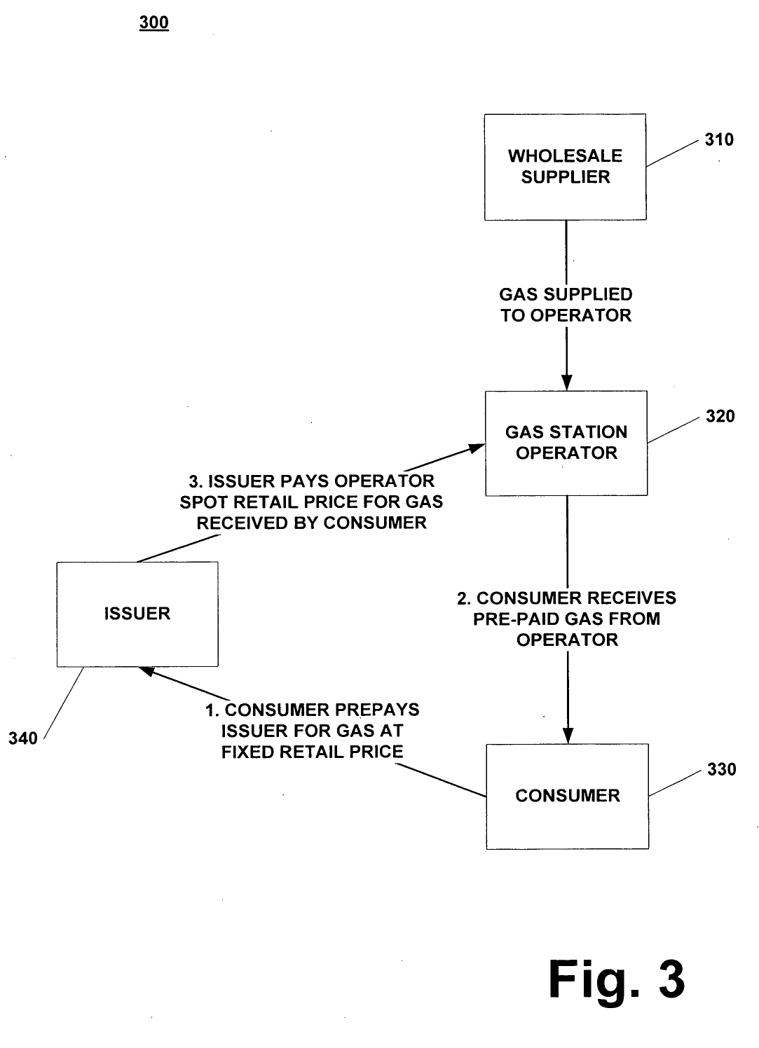

FIG. 3 shows the cooperation of exemplary market participants of an illustrative implementation of a prepaid gasoline transaction platform for retail transactions. For the purpose of illustration, gasoline is shown supplied by a wholesale gasoline supplier 310 to a gas station operator 320 in any conventional manner, such as delivery by tanker truck to underground storage tanks at a gas station. In an exemplary implementation, a new market participant, herein arbitrarily designated for purposes of illustration an “issuer” 340, agrees with the operator 320 to pay to the operator a price (e.g., a price based on the market price as of the time of the agreement between the issuer and operator or a price based on the market price when the gasoline is redeemed by a consumer) for gasoline delivered by the operator to a consumer 330. The issuer 340 also agrees with the consumer 330 to guarantee a fixed retail price to the consumer for gasoline to be purchased from the operator 320. The fixed retail price can be the retail market price plus an adjustment, such as market price plus a price risk premium. Optionally, the agreements can be effective for a fixed period of time, such as for a period of months.

As is shown in FIG. 3, in step 1, the consumer 330 prepays issuer 340 for a predetermined quantity of gasoline at the fixed retail price. The issuer 340 provides a prepaid gasoline debit account for the consumer 330, representative of the quantity of gasoline for which the consumer has prepaid the issuer at the fixed retail price. The debit account can be provided for the consumer in conjunction with a prepaid gasoline debit card, for indicating the quantity of gasoline prepaid for by the consumer at the fixed retail price. In an exemplary operation, the consumer 330 receives gasoline from the operator 320, such as by filling the gas tank of his car at a gas station operated by operator 320. The consumer's prepaid gasoline debit account is debited for the quantity of gasoline received. The issuer 340 pays the gas station operator 320 for the gasoline received by the consumer 330, at a price based on the retail price, such as the retail market price the operator would have charged the consumer for the gasoline if the consumer had not prepaid for it. If the retail market price at the time the consumer receives the gasoline is less than the fixed retail price at which the consumer prepaid for the gas, the issuer may realize a gain. In the exemplary operation, if the retail market price at the time the consumer receives the gasoline is higher than the fixed retail price at which the consumer prepaid for the gas, the issuer may realize a loss.

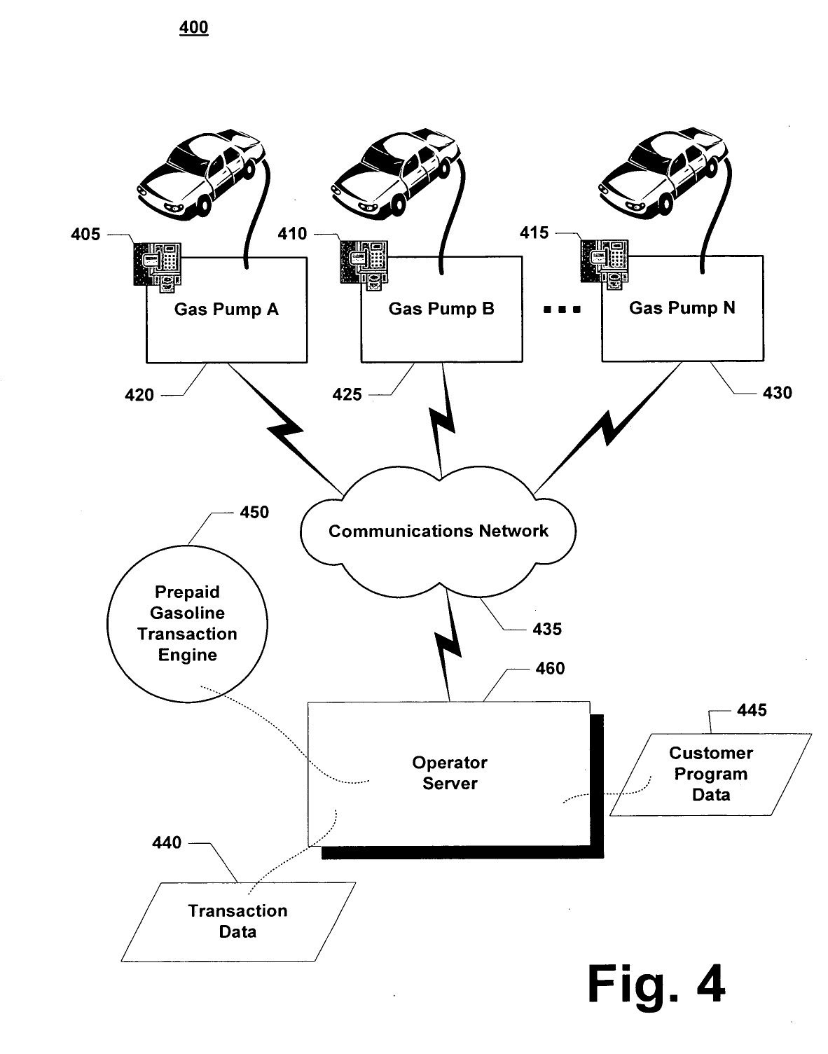

FIG. 4 shows an illustrative implementation of exemplary prepaid gasoline transaction platform 400, such as would be used for retail transactions. As is shown in FIG. 4, exemplary prepaid gasoline transaction platform 400 comprises one or more operator gas pumps, such as operator gas pump 420, operator gas pump 425 up to and including operator gas pump 430, communications network 435, server computing environment 460, prepaid gasoline transaction engine 450, data storage containing transaction data 440, and data storage containing customer program data 445. Also, as is shown in FIG. 4, prepaid gasoline transaction platform comprises card readers 405, 410, and 415, shown reading gasoline debit cards, associated with operator gas pumps 420, 425, and 430, respectively. Communications network 435 can comprise one or more of fixed-wire and/or wireless intranets, extranets, and the Internet.

In an illustrative operation, a consumer uses his gasoline debit card with a card reader associated with a gas pump when ready to pump gasoline into his car, to identify the prepaid account that will be debited for the gasoline. The consumer then pumps gasoline from the pump, which measures the gasoline pumped using a meter (not shown). After the gasoline is pumped, a transmitter on the gas pump (not shown), such as one of operator gas pumps 420, 425, and 430, communicates the consumer identifying information and quantity of gasoline pumped to server computing environment 460 over communications network 435. In the illustrative operation, prepaid gasoline transaction engine 450 can operate on server computing environment 460 to provide one or more instructions to server computing environment 460 to debit a prepaid consumer gasoline account, to keep an accounting of the prepaid gasoline paid for and received by the consumer. The consumer's debit account information and other data pertinent to the transaction (collectively “transaction data”) can be stored in transaction data storage 440. In addition, prepaid gasoline transaction engine 450 can operate on server computing environment 460 to provide processing in support of one or more customer programs using customer program data stored in customer program data storage 445. Such programs can include, for example, marketing programs directed to consumers.

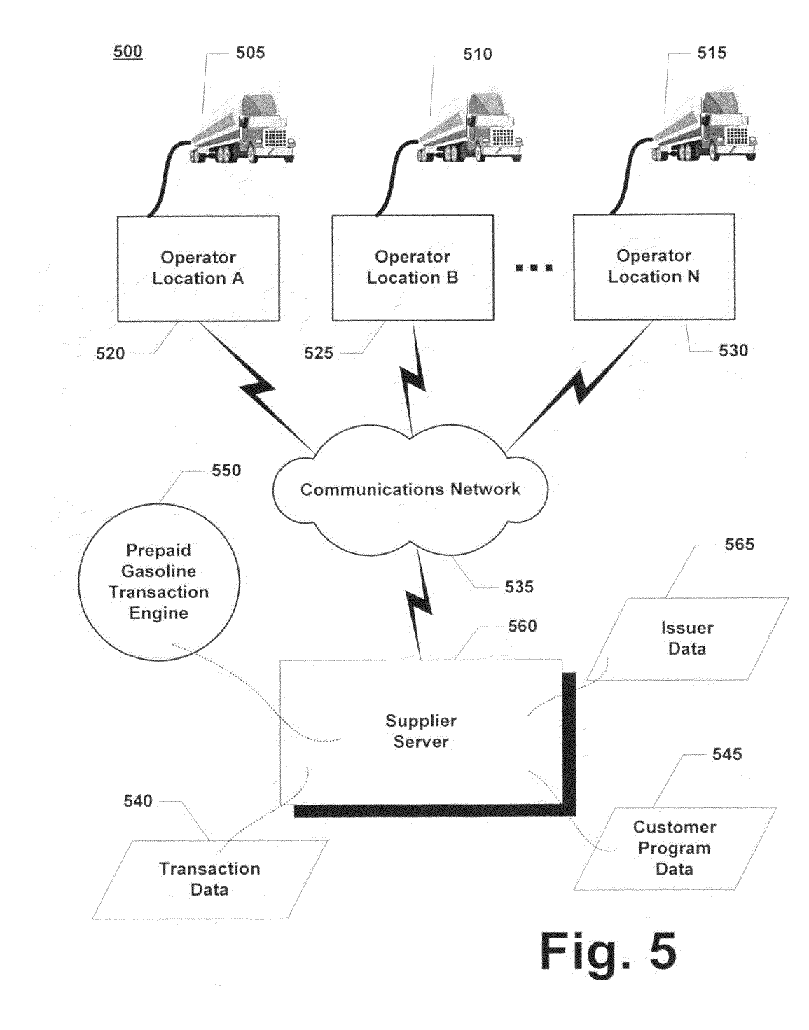

FIG. 5 shows an illustrative implementation of exemplary prepaid gasoline transaction platform 500, such as would be used for issuer transactions. As is shown in FIG. 5, exemplary prepaid gasoline transaction platform 500 comprises one or more operator storage tanks, such as operator (e.g., buyer) storage tank 520, operator storage tank 525, up to and including operator storage tank 530, communications network 535, server computing environment 560, prepaid gasoline transaction engine 550, data storage containing transaction data 540, and data storage containing customer program data 545. Communications network 535 can comprise one or more of fixed-wire and/or wireless intranets, extranets, and the Internet

As is shown in FIG. 5, prepaid gasoline transaction platform 500 can optionally operate without card readers. Instead, another method (not shown) can be used to provide operator identifying information to the system, such as a keyboard (not shown) to type the information, or a scanner (not shown) to scan a bar code containing identifying information (not shown), or any other means of identifying the operator.

In an illustrative operation, a tanker truck, such as tanker truck 505, 510, or 515, delivers gasoline to the operator, such as by pumping gasoline into a storage tank such as storage tanks 520, 525, or 530. Operator identifying information and the quantity of gasoline delivered are electronically communicated in a desired manner to the computing environment 560, such as over communications network 535. In the illustrative operation, prepaid gasoline transaction engine 550 can operate on server computing environment 560 to provide instructions to server computing environment 560 to track the quantity of gasoline delivered to the operator as part of the wholesale transaction.

In the illustrative operation, the operator can enter into a transaction with the gasoline wholesale supplier (not shown) such that the operator agrees to pay the supplier a per unit quantity buyer price for a predetermined quantity of gasoline (e.g., operator will pay $2.50 per gallon of gasoline for 100,000 gallons of gasoline). The operator in this illustrative transaction will agree to take delivery of the total predetermined quantity of gasoline.

In an illustrative operation, the operator can enter into an agreement with an issuer according to one or more operator/issuer pricing models so that the issuer can issue to a consumer prepaid gasoline debit cards which can be sold to consumers (not shown) for a pre-determined quantity of gasoline according to a fixed retail price (e.g., $150 debit card which reflects 50 gallons of gasoline at $3 per gallon. Server 560 can illustratively operate according to instructions from prepaid gasoline transaction engine to keep an accounting of the gasoline for which the consumer has prepaid and received when using the prepaid gasoline debit card issued by the issuer. Additionally in the illustrative implementation, the transaction data can be stored in transaction data storage 540. Furthermore, issuer information can be stored in issuer data store 565. In addition, prepaid gasoline transaction engine 550 can operate on server computing environment 560 to provide processing in support of one or more customer programs using customer program data stored in customer program data storage 545. Such programs can include, for example, marketing programs directed to operators.

Exemplary customer programs can optionally include discounts, points, or special offers for additional products and/or services offered to the buyer by the seller and/or an affiliate, discounts for gasoline received by the buyer in accordance with a preferred schedule as determined by the seller, or the like.

In the illustrative implementation, the one or more pricing programs can comprise a pricing model where the issuer pays to the operator a price based on the market price as of the time of the agreement for gasoline to be transacted by the operator to the consumer or where the issuer pays to the operator a price based on the market price when the gasoline is redeemed (i.e., when the prepaid gasoline debit card is used by the consumer when he purchases gas) by the consumer. In this illustrative implementation, if the operator believes that the price of gasoline will decrease over time, the operator might opt to be paid at the time of the operator/issuer agreement. Conversely, if the operator believes that the price of gasoline will increase over time, the operator might opt to be paid when the consumer redeems the gasoline using the purchased prepaid gasoline debit cards purchased from the issuer. In the illustrative implementation, the consumer will opt to purchase the prepaid gasoline debit card at a fixed retail price (which can be the market price plus a premium for being allowed to lock into a price) if the consumer believes that the price of gasoline will increase over time. In the illustrative implementations, the issuer bears the risk with increasing and decreasing market prices and can operate to hedge its risk (i.e., its position with the quantity of gasoline committed to purchase from the operator at either a price based on the agreement market price or a price based on the time of purchase market price and the position with consumers to whom the issuer has sold prepaid gasoline debit cards at the fixed retail price) with other market participants (e.g., purchase of gasoline futures, etc.) to protect against a loss.

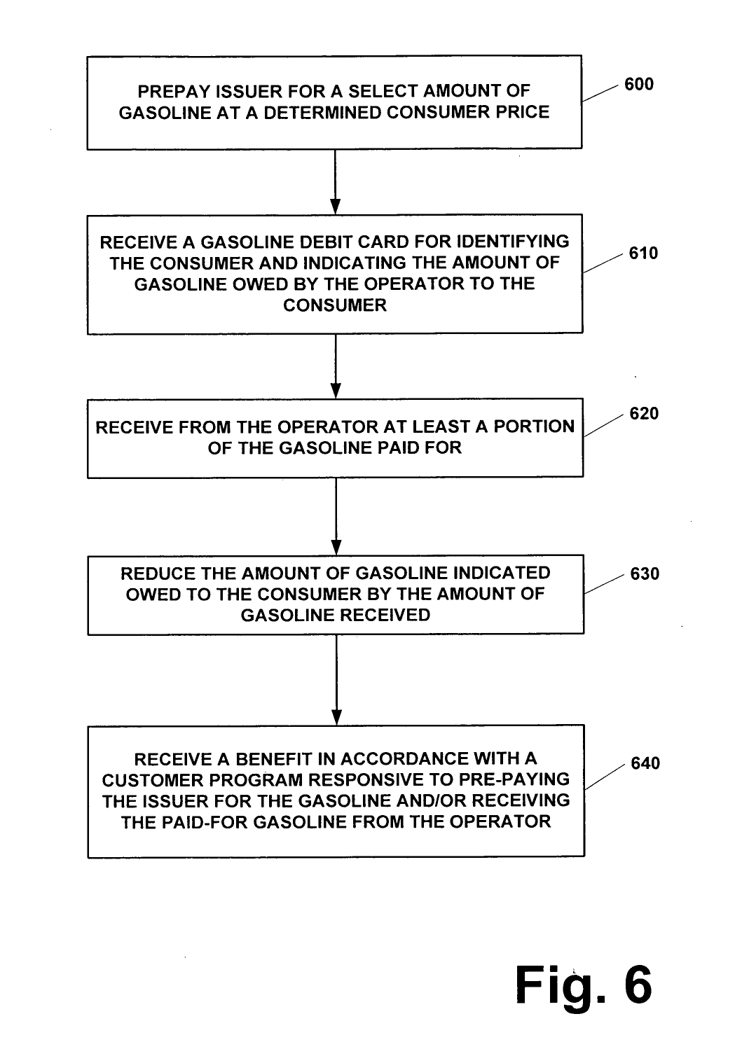

FIG. 6 shows exemplary steps performed when using an illustrative implementation of prepaid gasoline transaction platform for retail transactions 400 of FIG. 4. As is shown, processing begins at block 600 where a consumer prepays an issuer (or operator) for a select quantity of gasoline at a determined consumer (retail-based) price. The consumer receives a gasoline debit card for identifying the consumer and indicating the quantity of gasoline owed by the operator to the consumer, 610. The quantity of gasoline owed by the operator to the consumer can be stored on the card, or at another location, such as transaction data storage 440. The consumer receives from the operator at least a portion of the gasoline paid for, 620. The consumer typically receives the gasoline from a gas pump, and uses a card reader associated with the gas pump to read the consumer identifying information from the gasoline debit card. Other means can alternatively be used to identify the consumer, such as using a keyboard to type in the identifying information, a FOB wand, a mobile phone, or other electronic payment means. The quantity of gasoline indicated owed to the consumer is reduced by the quantity of gasoline received, 630. Optionally, the consumer can receive a benefit in accordance with a customer program, 640. The benefit can be received responsive to the consumer pre-paying for the gasoline, and/or responsive to the consumer receiving the paid-for gasoline from the operator.

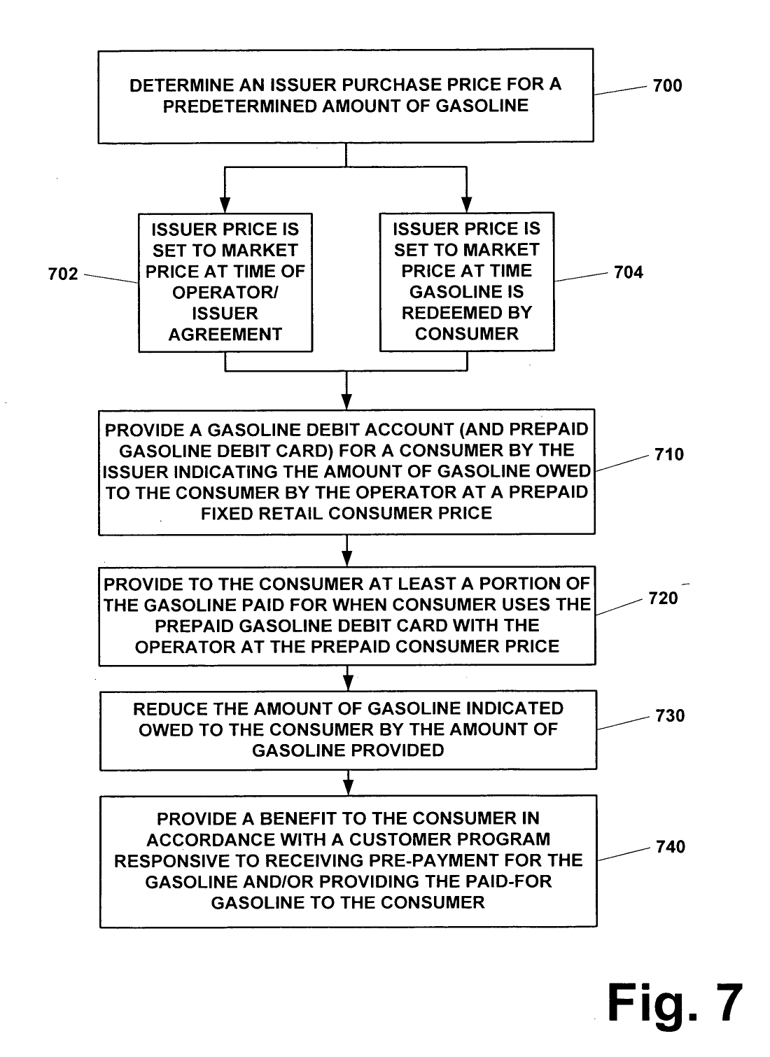

FIG. 7 shows exemplary processing performed when using an illustrative implementation of prepaid gasoline transaction platform, such as 400 of FIG. 4. As is shown, processing begins at block 700 where an issuer price is determined for a predetermined quantity of gasoline, at which an issuer can afterward pay an operator for the gasoline. The issuer purchase price can be based on one or more pricing models comprising the issuer paying a price based on the retail market price for a quantity of gasoline at the time an agreement is entered into between the issuer and operator as shown in block 702 or the issuer paying a price based on the retail market prices for a quantity of gasoline at the time a consumer redeems gasoline through the use of a prepaid gasoline debit card as show in block 704.

In the illustrative implementation, the issuer can sell prepaid gasoline to consumers in predetermined amounts at a prepaid fixed retail consumer price. A gasoline debit account is provided for a consumer by the issuer, indicating the quantity of gasoline owed to the consumer by the operator at the prepaid consumer price, 710. A prepaid gasoline debit card can also be provided to the consumer by the issuer. Thereafter, at least a portion of the gasoline paid for is provided to the consumer by the operator when the consumer uses the prepaid gasoline debit card to receive gasoline from the operator at the prepaid consumer price, 720. The quantity of gasoline indicated owed to the consumer is reduced by the quantity of gasoline provided, 730. Optionally, the issuer and/or operator can provide a benefit to the consumer in accordance with a customer program, 740. For example, the benefit can be provided responsive to receiving pre-payment for the gasoline, and/or providing the paid-for gasoline to the buyer, such as in accordance with a schedule preferred by the seller.

In an illustrative operation, if the operator opts to be paid by the issuer at a price based on the market price at the time the agreement is entered into by the issuer and operator (e.g., a price based on the time-of-agreement retail market price), the issuer makes a payment to the operator based on the market price at the time the agreement is entered into by the issuer and operator (e.g., 100,000 gallons of gasoline at $2.50 per gallon (time-of-agreement retail market price) totaling $250,000). In the illustrative implementation, if the operator opts to be paid by the issuer at a price based on the market price at the time the consumer redeems the prepaid gasoline debit card (time-of-consumer-redemption retail market price), the issuer makes a payment to the operator based on the market price at the time the consumer redeems the prepaid gasoline debit card (e.g., 100,000 gallons of gasoline at $3.00 per gallon (time-of-consumer-redemption market price) totaling $300,000).

It is appreciated that although the issuer is described to pay the operator after the consumer purchase of the gasoline, that such description is merely illustrative as the inventive concepts described herein contemplate an illustrative implementation in which the issuer can pay the operator in full and in advance for the quantity of gasoline to be sold under the issued prepaid gasoline debit cards (e.g., up front payment of $2,000,000 by the issuer to the operator for 1 million gallons of gasoline at $2/gallon to be transacted by the issuer).

In exemplary implementations, the prepaid retail or wholesale prices can include restrictions on the time of receipt or delivery of the prepaid gasoline. For example, pricing can be contingent on delivery of gasoline in accordance with a determined schedule, and/or during a determined amount of time, such as a levelized quantity of gasoline delivered per month, the entire prepaid quantity to be received within a year. In exemplary implementations, benefits can be conferred upon a consumer or buyer for adjusting his buying patterns to conform to a schedule preferred by the seller.

It is appreciated that although the cooperating parties of described in FIGS. 3-7 are shown to have distinct roles that such description is merely illustrative as the inventive concepts described herein contemplate the cooperation of various parties having combined roles. For example, in the illustrative implementations described in FIGS. 3-7, the issuer and operator are described as separate entities. The inventive concepts described herein contemplate illustrative implementations in which the operator and issuer are the same party.

It is understood that the herein described systems and methods are susceptible to various modifications and alternative constructions. There is no intention to limit the herein described systems and methods to the specific constructions described herein. On the contrary, the herein described systems and methods are intended to cover all modifications, alternative constructions, and equivalents falling within the scope and spirit of the herein described systems and methods.

It should also be noted that the herein described systems and methods can be implemented in a variety of electronic environments (including both wired and wireless networked environments), partial computing environments, and other real world environments. The various techniques described herein may be implemented in hardware or software, or a combination of both. Preferably, the techniques are implemented in computing environments maintaining programmable computers that include a computer network, processor, servers, a storage medium readable by the processor (including volatile and non-volatile memory and/or storage elements), at least one input device, and at least one output device. Computing hardware logic cooperating with various instructions sets are applied to data to perform the functions described above and to generate output information. The output information is applied to one or more output devices. Programs used by the exemplary computing hardware may be preferably implemented in various programming languages, including high level procedural or object oriented programming language to communicate with a computer system. Illustratively the herein described apparatus and methods may be implemented in assembly or machine language, if desired. In any case, the language may be a compiled or interpreted language. Each such computer program is preferably stored on a storage medium or device (e.g., ROM or magnetic disk) that is readable by a general or special purpose programmable computer for configuring and operating the computer when the storage medium or device is read by the computer to perform the procedures described above. The apparatus may also be considered to be implemented as a computer-readable storage medium, configured with a computer program, where the storage medium so configured causes a computer to operate in a specific and predefined manner.

Although exemplary implementations of the herein described systems and methods have been described in detail above, those skilled in the art will readily appreciate that many additional modifications are possible in the exemplary embodiments without materially departing from the novel teachings and advantages of the herein described systems and methods. Accordingly, these and all such modifications are intended to be included within the scope of the herein described systems and methods. The herein described systems and methods may be better defined by the following exemplary claims.

What is claimed is:

1. A method for a consumer to buy gasoline at a predetermined price, comprising:
enabling a consumer to prepay an operator for a selected quantity of gasoline at a prepaid gasoline price determined by an issuer;
issuing to the consumer a gasoline debit card for identifying the consumer in connection with gasoline purchases made using the gasoline debit card;
enabling the consumer to purchase a quantity of gasoline not to exceed the selected quantity from the operator using the gasoline debit card; and
reducing the prepaid quantity of gasoline indicated owed to the consumer by the purchased quantity of gasoline received by the consumer.

2. The method of claim 1, further comprising:
providing a benefit to at least one of the consumer and the operator in accordance with a customer program responsive to the consumer's purchase of gasoline using the gasoline debit card.

3. The method of claim 1, wherein the operator is also the issuer.

4. The method of claim 1, further comprising:
calculating the prepaid gasoline price based on a market price of gasoline at the time of an agreement between the issuer and the operator to provide prepaid gasoline by the operator to consumers using gasoline debit cards issued by the issuer.

5. The method of claim 1, further comprising:
calculating the prepaid gasoline price based on a market price of gasoline at the time the consumer makes a gasoline purchase with the gasoline debit card.

6. The method of claim 1, wherein information pertaining to the quantity of gasoline owed to the consumer is stored on the gasoline debit card.

7. The method of claim 1, wherein information pertaining to the quantity of gasoline owed to the consumer is stored on a server.

8. A computer readable medium having computer readable instructions to instruct a computer to perform a method comprising:
receiving from an operator information pertaining to a quantity of gasoline purchased from the operator by a consumer using a prepaid gasoline debit card issued by an issuer; and
reducing a prepaid quantity of gasoline indicated owed to the consumer by the quantity of gasoline purchased.

9. The computer readable medium of claim 8, the method further comprising:
determining a benefit to be provided to at least one of the consumer and the operator in accordance with a customer program, responsive to the consumer's purchase of gasoline using the prepaid gasoline debit card.

10. The computer readable medium of claim 8, the method further comprising:
calculating a sales price for use by the operator for the gasoline purchased by the consumer using the gasoline debit card, based on the retail market price of gasoline at the time of the purchase

11. A system for a consumer to buy gasoline at a prepaid price, comprising:
a prepaid gasoline debit card having consumer information;
a card reader for reading the consumer information;
a meter for measuring a quantity of gasoline purchased;
a transmitter for sending transaction data pertaining to a gasoline purchase made using the gasoline debit card, including the consumer information and the quantity of gasoline purchased;
a communications network for conveying the transaction data; and
a server arranged with a receiver for receiving the transaction data, the server arranged for storing a consumer prepaid gasoline account for indicating a quantity of prepaid gasoline owed to the consumer, and to reduce the quantity of prepaid gasoline by the quantity of gasoline purchased.

12. The system of claim 11, further comprising:
a prepaid gasoline transaction engine for keeping an accounting of the prepaid gasoline paid for and received by the consumer.

13. The system of claim 11, further comprising:
transaction information storage for storing consumer gasoline debit account information and transaction data.

14. The system of claim 11, further comprising:
customer program data storage for storing customer program data for use in one or more customer programs.

15. The system of claim 14, wherein the customer programs include one or more marketing programs directed to consumers.

16. The system of claim 11, wherein the communications network comprises at least one of a wired network and a wireless network.
